(19) United States
(12) Patent Application Publication
(10) Pub. No.: US 2011/0286790 A1
(43) Pub. Date: Nov. 24, 2011

(54) Remotely actuatable pendulum binary latch

(76) Inventor: Peter Stone, Brooklyn, NY (US)

(21) Appl. No.: 13/138,314

(22) PCT Filed: Feb. 2, 2010
(86) PCT No.: PCT/US2010/000282

§ 371 Date: Aug. 1, 2011

Related U.S. Application Data
(60) Provisional application No. 61/206,738, filed on Feb. 4, 2009.

(51) Int. Cl. F16B 7/00; B23P 11/00

(52) U.S. Cl. 403/322.3; 29/428

(57) ABSTRACT

A remotely actuatable latch for locking and releasing an object at a location remote from a user includes a sheave mounted at the remote location for free rotation about an axis. A line is engaged with the sheave and has one end coupled to an object to be selectively locked or released at the remote location and an opposing end that can be gripped and manually manipulated by a user at a location spaced from the remote location. A shackle connects the object to the line. A pendulum at the remote location is pivoted for movements between a stable position and an unstable position and positioned along the path of movement of the line and shackle when a user pulls or releases the opposing end. The pendulum has a cam surface for deflecting the pendulum responsive to movements of the shackle along the path of movement past the pendulum towards the sheave to cause the shackle to ride along the cam surface thereby angularly pivoting the pendulum from the stable rest position to the unstable position. The pendulum has an engaging mechanism for engaging the shackle and has a natural period of oscillation selected to require a time τ to move from the unstable to the stable positions, whereby release of the line to allow the shackle to free fall past said pendulum with a time less than τ allows the shackle to clear the pendulum and unlock the object while controlled release of the line to move the shackle with a time sufficiently greater than τ causes the pendulum engaging mechanism to engage the shackle and fixedly secure the object to the pendulum, whereby a user can lock or unlock the shackle and therefore also the object at the remote location by controlling the speed of release of the line.

### BACKGROUND OF THE INVENTION

1. Field of the Invention

The present invention generally relates to remotely actuable latches for locking or releasing a line or one object relative to another and, more specifically, to a pendulum binary latch that can lock or release a line or one object relative to another by manually altering the speed of movement of the line or one of the objects relative to the natural period of oscillation or swing of a pendulum that can either snag the line or one of the objects or allow the line or one of the objects to advance relative to the position of the pendulum.

2. Description of the Prior Art

Latches, as mechanical fasteners, have been known and used to for a long time. Generally, a latch is a type of mechanical fastener that is used to join two (or more) objects together while allowing for the regular or eventual separation of the objects from each other. Latches range in complexity from flexible one-piece flat springs of metal or plastic, such as are used to keep blow molded plastic power tool cases closed, to multi-point cam latches used to keep large doors closed. Common types of latches include spring, slam, cam, crossbar and other latches. Most latches are operated manually by manipulating one of the mating or cooperating elements or components of the latch to either release or join two objects or surfaces secured by the latch. Thus, while a latch is typically simple in construction and easy to operate at close range, the latch, as a coupling for joining or separating two objects or surfaces at a remote distance has been a challenge.

While a latch that can be easily and conveniently remotely controlled could have many potential applications, one application that has been the focus of much effort has continued to be elusive. This application involves the use of a latch on the mast of a pleasure boat or competition yacht that has a mainsail that needs to be selectively secured or released from the top of the mast. Normally, a mainsail is guided along a rail vertically disposed on a mast where the sail is kept under tension when it is in the hoisted position. This tension is applied to the said by initially applying a tension on a halyard that hoists the sail, by using a pulley block at the masthead. The halyard, which is attached by means of a shackle or the like is attached to the head of the sail as it passes over the pulley that is pivotably mounted on the upper part of the mast. The line returns along the mast, typically on the interior or exterior of the mast. During navigation, the wind, which is the element propelling the boat, exerts pressure on the entire sail. This pressure is represented by forces applied to the mast that may reach many several hundred decanewtons (daN). These forces are applied to both the halyard and the downhaul. To prevent the halyard from becoming longitudinally stretched under the action of this pressure and reducing the tension applied to the sail halyards composed of stainless steel cables or of a synthetic material with a low coefficient of elongation, such as a material known under the name of Kevlar, are generally used. However, stainless steel halyards are difficult to use and Kevlar halyards a very costly and require careful handling. It has, therefore, been proposed that when the sail is fully foisted by means of the halyard, which passes over a pulley or block disposed at the masthead, that the sail be secured to the masthead to ensure that the sail is held in that position independently of the halyard. The halyard, therefore, is no longer required to exert tensile force on the sail and may be made of a textile material or of extensible synthetic materials such as nylon. Remotely controlled latches have been proposed for this application. However, it is also important that such remotely controlled latches be simple in construction, easy or convenient to use and are extremely reliable. The previously proposed devices have not satisfied all of these criteria.

In U.S. Pat. No. 2,673,116 a releasable hoisting device is disclosed for releasably supporting loads however, a separate trip line is used to release the latch. Similarly, in U.S. Pat. No. 4,586,480 a safety device is disclosed for fastening the head of the sail to a masthead. A snap shackle is used with a trip line for releasing the catch. In the latter patent, the device is disclosed for fastening the head of a jib sail. However, the use of an additional trip line complicates the construction as well as the operation of the safety device. Along the same lines, a remotely controlled grapnel hook has been proposed that is operated by means of fluid pressure that can be selectively applied to release the fluid pressure in a cylinder against the force of a spring. With the latter arrangement, the hook apparatus can be remotely controlled. However, the disclosed device requires a source of fluid pressure and makes use of a complicated construction of numerous parts, rendering the device less reliable.

A more recent attempt to solve the general problem is disclosed in US Published Patent Application No. 2008/014-8556, disclosing a device for the connection/disconnection of two elements from any relative axial movements between these two elements. This published patent application makes use of two elements that become latched together, with one of the elements comprising a locking member that can move successively from a released position to a locked position relative to the other member or element. However, this device has a complicated construction, rendering it more costly to manufacture and less reliable. Additionally, because the device exhibits a generally symmetrical configuration in relation to an axis of symmetry the design is not conducive for readily mounting on mastheads of conventional masts. Thus, the device is provided with an upper yoke that can be used to secure the device to the top of a mast. However, in order to withstand large forces that are experienced such a line connecting the yoke to the mast must have the ability to withstand significant tension forces, PBO lines frequently being used for this purpose. This is a further disadvantage of this device in addition to its complexity and cost.

As suggested, most latches are designed to be remotely controlled or regulated either by an auxiliary trip line or, in some instances, by a halyard whose position must be carefully and even critically controlled in order to achieve the desired functionality.

Also known are inertia latches most frequently utilized in conjunction with vehicle seats. See, for example, U.S. Pat. Nos. 4,429,919; 3,628,831 and 4,909,571. While latches in this category frequently utilize a pivotally mounted pendulum such pendulums are typically actuated by both gravity acceleration as well as acceleration due to inertia. They do not normally react to forces manually applied by an operator. These latches are automatic and respond to impacts on the vehicle.

Numerous other applications have failed to recognize practical solutions. Thus, for example, large banners at stadiums, convention centers and retail establishments have used banners and advertising posters to draw attention to events, promotions, sales, etc. However, such materials are frequently mounted high above floor level and periodically changing such materials has been difficult and costly, resulting in less frequent updates or changes than would normally be desirable or warranted.

The prior art has not disclosed a remotely operated latch that does not require a trip line yet is extremely simple and reliable to use even under demanding conditions and can withstand an entire range of forces ranging into many tons of force.

### SUMMARY OF THE INVENTION

Accordingly, it is an object of the invention to provide a new and novel latch that can be used for numerous applications.

It is another object of the invention to provide a latch as in the previous object that can be easily and conveniently remotely operated.

It is still another object of the invention to provide a latch that is simple in construction and economical to manufacture

it is yet another object of the invention to provide a latch as in the previous objects that is extremely reliable.

It is a further object of the invention to provide a latch of the type under discussion that is well-suited for securing the head of the sail to the masthead without regard to critical movements or positions of the halyard.

It is still a further object of the invention to provide a latch as in the previous objects that can withstand the forces or tensions that that can be anticipated in both small and large vessels.

It is yet a further object of the invention to provide a latch of the type under discussion whose operation is a function of the period of a pendulum and the acceleration resulting from the force of gravity.

### BRIEF DESCRIPTION OF THE DRAWINGS

Preferred embodiments of the present invention will now be described, by way of example only, as illustrated in the appended drawings, in which:

FIG. 1a is a side elevational view of a latch in accordance with the present invention, shown in cross-section taken along line 1a-1a in FIG. 1d, showing the latch with a pendulum in an upper line releasing position;

FIG. 1b is similar to FIG. 1a, showing the pendulum in a lowered line arresting or latching/locking position;

FIG. 1c is similar to FIG. 1b but showing a neutral position of the pendulum when tension is removed from the line;

FIG. 1d is a cross-sectional view of the latch shown in FIG. 1C, one taken along line 1d-1d;

FIG. 2a is a side elevational view of another embodiment of the latch in accordance with the invention, shown mounted and secured to a masthead with the sail being hoisted and proximate to its uppermost position;

FIG. 2b is similar to FIG. 2a, but showing the head of a shackle, secured to the head of the sail, engaging a camming surface of the pendulum to raise the pendulum upwardly against the force of gravity;

FIG. 2c is similar to FIG. 2b, shown with the shackle and sail in a further elevated position to pivot the pendulum upwardly;

FIG. 2d is similar to FIG. 2c, showing the head of the sail and supporting shackle in its uppermost position, deflecting the pendulum to its maximum angular or rotational travel;

FIG. 2e is similar to FIG. 2d, shown when the halyard is controllably released to allow the sail and supporting shackle to drop from the position shown in FIG. 2d, but sufficiently slowly to allow the pendulum to swing and intercept and engage the head of the shackle;

FIG. 2f is similar to FIG. 2e, showing the shackle fully secured and supported by the pendulum so that the forces generated within the sail are directly transmitted to the masthead while removing all tension from the halyard;

FIG. 2g is a cross-sectional view of the arrangement is shown in FIG. 2a, taken along line 2g-2g;

FIG. 3a is a side elevational view of a further embodiment of the latch in accordance with the present invention, showing an additional complementary support member for the shackle mounted on the masthead;

FIG. 3b is a cross-sectional view of the embodiment shown in FIG. 3A, taken along line 3b-3b;

FIG. 3c is similar to FIG. 3b, shown with the pendulum in a partially raised position in response to the raising of the shackle;

FIG. 3d is similar to FIG. 3c, shown with the pendulum in its uppermost position as a result of the lifting of the sail by the shackle to its uppermost limit;

FIG. 3e is a force diagram representing the forces acting on the shackle in FIG. 3B;

FIG. 4a is a cross-sectional view of a shackle in accordance with another arrangement that is used to secure a spinnaker sail, as the halyard is pulled to hoist the sail and the shackle engages the cam surfaces of the pendulum to partially deflect the pendulum from the general direction of the line;

FIG. 4b is similar to FIG. 4a, but showing the spinnaker and supporting shackle at the extreme or upper position to fully deflect the pendulum;

FIG. 4c is similar to FIG. 4b after the tension has been removed from the halyard and the pendulum has rotated to a fully closed position to lock or secure the shackle directly to the masthead;

FIG. 4d is similar to FIGS. 4a-4c, showing the shackle moved sufficiently rapidly in the direction of the arrows to escape locking engagement between the head of the shackle and the pendulum;

FIG. 5a is a front elevational view of a further embodiment of a shackle in accordance with the invention, used to secure a jib as with the previously described sails;

FIG. 5b is a side elevational view of the latching arrangement is shown in FIG. 5a, showing the halyard secured by the pendulum of the invention to secure and maintain the jib at its topmost position;

FIG. 6 is a detail of the arrangement shown in FIG. 5b, showing the details of the block to accommodate knots, beads or other protuberances on the halyard to allow the jib to be fixed in multiple positions;

FIG. 7 is a detail of the pendulum shown in FIGS. 5a, 5b;

FIG. 8a is a cross-section of a bead or knot construction that can be used on the halyard shown in FIG. 5b;

FIG. 8b is a cross-sectional view of another bead construction that can be used in FIGS. 5a-5b;

FIGS. 9a-9c are similar to FIG. 5b and illustrate the sequence of actions in releasing or lowering the jib sail from its uppermost position shown in FIGS. 5a, 5b;

FIG. 10a is a front elevational view is still another embodiment of a latch in accordance with the present invention, primarily for use with a mainsail of a large yacht that provides for three different positions of the mainsail;

FIG. 10b is a side elevational view of the embodiment shown in FIG. 10a;

FIGS. 11a-11c. are similar to FIG. 10b but showing different conditions of the latch for locking or releasing the mainsail;

FIGS. 12a-12c are similar to FIGS. 11a-11c, respectively, but showing the mainsail being locked at an intermediate position or height relative to the mast;

FIGS. 13a-13b illustrate yet another embodiment of the latch of the invention, showing a latch construction suitable for other applications, such as releasably securing a load at a desired upper position during construction or the like;

FIGS. 14a-14b show an alternate embodiment of the latch of the invention, shown in a light household application, such as raising and lowering a potted house plant or for other gardening applications;

FIGS. 15a-15c illustrate a further application of the latch when used in conjunction with a wall-mounted movable cabinet or storage device cooperates with a stationary latch;

FIGS. 16a-16d illustrate the operation of the latch for the application shown in FIGS. 15a-15c; and

FIGS. 17a-17b illustrate a further application for the latch of the invention in which the latch is movable, whereas in FIGS. 15a-15b the latch is stationary;

FIGS. 18a-18c illustrate the operation of the latch for the application shown in FIGS. 17a-17b;

FIG. 19a is a side elevational view of a further application of the latch of the invention for raising and lowering a banner for locking the same in an upper operative position and to change or replace the banner, respectively, and showing enlarged details of a mounting bracket and the pendulum operation;

FIG. 19b is a perspective view of the pendulum used in the application shown in FIG. 19a;

FIG. 19c is an end elevational view of the latch and banner application shown in FIG. 19a, and showing enlarged details of the pendulum and the banner attachment clips or clamps;

FIG. 19d is similar to FIG. 19c but showing another banner/sign attachment/detachment mechanism from the one shown in FIGS. 19a and 19c, and showing enlarged details of the banner attachment eyelets;

FIG. 20a is similar to FIG. 19a but showing a banner in the upper locked position and the control line extending through a support wall to bring the control line within a building structure; and

FIG. 20b is similar to FIG. 20a but showing the device in the lowered position of the banner to facilitate the removal or the changing of the banner without the need to use ladders or the like.

### DESCRIPTION OF PRESENTLY PREFERRED EMBODIMENTS

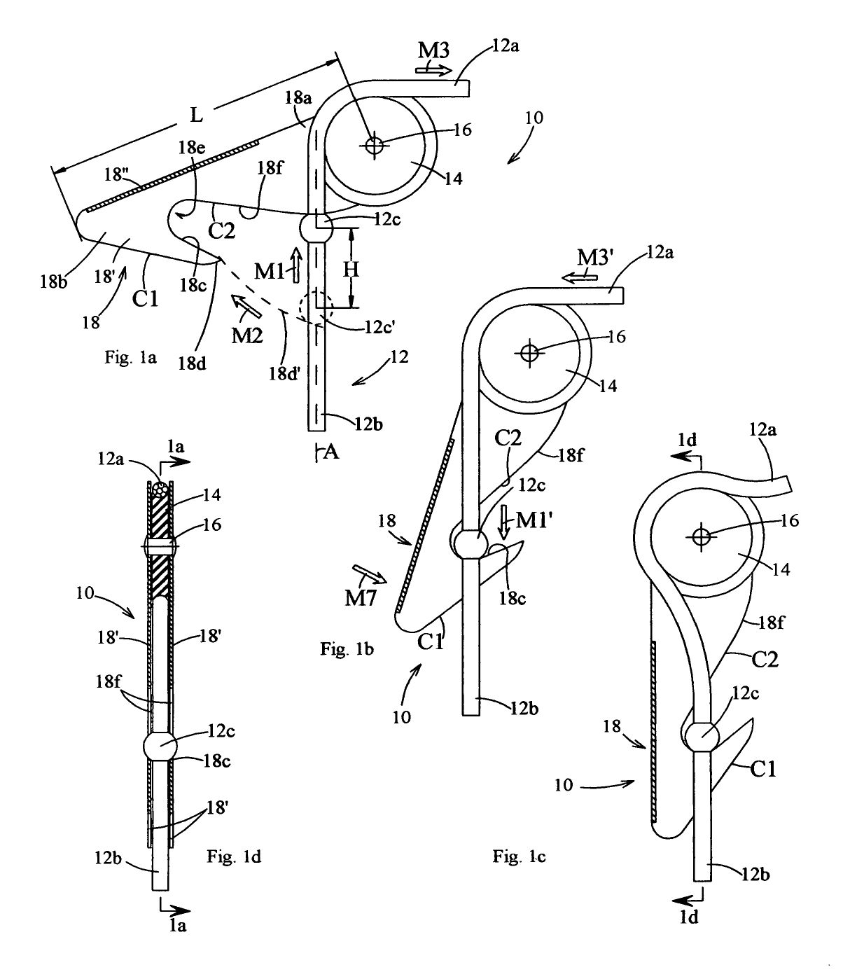

Referring now more specifically to the drawings, in which identical or similar parts are designated by the same reference numerals throughout and first referring to FIGS. 1a-1d a latch in accordance with the present invention is generally designated by the reference numeral 10.

In the embodiment illustrated in FIGS. 1a-1d the latch 10 is formed of stamped sheet material, such as steel for heavier applications. However, the latch may also be formed of other materials such as a plastic for lighter applications. The latch 10 is used to control the advancement of a line 12, such as a halyard for a sail, by selectively locking or arresting the line or releasing it, as will be more fully described hereinafter. However, while most of the embodiments will be described in the context or environment of sailing boats or yachts it will be evident to those skilled in the art that the latch of the present invention has numerous, if not unlimited, applications in many fields of endeavor.

The line 12 passes over a pulley or block 14 rotatably mounted on a shaft 16, generally arranged in a horizontal plane. A feature of the invention is the provision of a pendulum 18. A proximate end 18a of the pendulum is pivotably mounted on the shaft 16 for angular or rotary movements about shaft, as to be described. A remote end 18b is provided with a hook portion 18c having a tip or pointed end 18d. The hook is formed with an inner region or recess receiving portion 18e at the inner end of the hook and with an outer lower edge forming a cam edge C1. An edge, in the form of a cam surface 18f or C2, extends from the inner or recessed portion 18e to the proximate end 18a, as shown. Both cam edges C1, C2 may form an angle relative to the length direction of the pendulum 18, such as 45°, although this angle is not critical, as be evident to those skilled in the art.

As best as shown in FIG. 1d, when formed as a stamping, the pendulum generally has a U-shaped cross-section with two spaced walls 18′ and a transverse or connecting wall 18″. The spacing between the walls 18′ is selected to be less than the dimensions of a bead or other enlarged member 12c so that the bead can be engaged by the hook 18c and be received within the recess portion 18e but cannot enter into the space between the two walls 18′.

The latch 10 is in the form of an interference coupling that utilizes an interference fit between an enlarged member, such as the bead 12c on the halyard, to arrest or stop the movement or advancement of the line or halyard while allowing the same to be selectively released and advanced when the interference fit has been eliminated or terminated. An important feature of the present invention is that the existence or absence of an interference fit can be selected by a user or operator of the latch by controlling the movements M2 of the pendulum the 18. As is well known, the movements of a pendulum are well defined by the following formula:

T₀=2π√L/g,

where T₀ is the period of the pendulum in seconds (sec), L is the length of the pendulum in meters (m), and g is the acceleration due to gravity and is approximately equal to 9.8 m/sec². This formula is accurate for small angles of swing of the pendulum, typically 10° or less. For larger angles of swing the formula becomes more intricate, but the period effectively increases beyond the period based on the above formula. At a point of the earth where the gravity is 9.8 m/sec², g/π²≅1 and the period of the pendulum with L=1 m is T₀≅2 seconds. Importantly, referring to FIG. 1a, a quarter of the period T₀ or T_{P}=T₀/4, the time it takes for the pendulum 18 to swing from its raised position shown in FIG. 1a to its dead center position along the vertical direction of the line 12 axis A. Thus, the time it takes the pendulum to swing from its raised position, in which the pendulum is “cocked” or “set” for selective further action such as releasing or latching actions, is:

T_{P}=π/2√L/g

The time it takes to release the line 12, T_{R}, is a time that requires the bead 12c to pass through a distance H from a higher position in which the bead abuts against the cam edge 18f, to maintain the pendulum in the raised position, to a position 12c′, shown in phantom outline along the path or locus of points 18d′ defined by the tip 18d of the hook 18c as the pendulum swings from the raised position to a position where the tip 18d intersects or crosses the axis A. When the bead 12c drops under the gravity force only the releasing time T_{R} according to Newton's law is defined by the following equation:

(T_{R})_{g}=√2H/g

For an exemplary practical design H≅0.5 L and the time (T_{R})_{g}=√L/g, so that without external interference or application of external forces the following ration R applies:

R=T_{P}/(T_{R})_{g}≈π2

The ration R is always greater than 1. So, the bead 12c, under the gravity force, drops faster than the hook 18c can reach the bead and the bead drops below the hook and escapes being snagged or arrested by the pendulum. However, the ratio T_{P}/T_{R} can be made less than 1 when the line 12 is artificially retarded or held back by an external force, to release the line more slowly. The pendulum hook tip 18d then reaches the axis A in time to block the descent of the bead below the position 12c′ and the bead is captured and retained in the hook to prevent the further advancement of the line.

During actual use, T_{R} is controlled by the user or operator of the latch 10 by controlling how quickly or slowly the line or halyard is released. Thus, when the line is to be released, the line 12 is allowed to free fall, while if the line is to be locked it is released more slowly to allow the hook 18c to engage and retain the bead 12c or other member, as to be described. An example of a practical pendulum length is L=0.1 m, in which case Tp≅0.157 sec and (T_{R})_{g}≅0.1 sec. So, to lock the bead 12c the releasing time T_{R} must be more than 0.157 second.

It will be appreciated that the latch is controlled by the very line or halyard that is to be locked or released, and the operation is only a function of gravity and the controlled release time that is regulated by the user. The operation does not rely on inertia or the use of any auxiliary trip line or other means for remotely releasing the line. The control of the line is, therefore, remotely controlled by the mere use of two elements—the swinging pendulum and the bead or other protuberance secured to the line and that shares the movements of the line.

In FIG. 1a the vertical line portion 12b has been moved upwardly (M1) by pulling the line at 12a (M3) to cause the bead to engage the inner cam edge C2, causing the pendulum 18 to reach its raised condition, in which it is arranged in a substantially horizontal plane, approximately 90° from the vertical. In FIG. 1b the line 12b has been permitted to drop (M1′), under the weight of a load, to lower the position of the bead 12c, this allowing the pendulum to rotate in a counterclockwise direction (M7) towards the vertical orientation. As indicated above, when the line speed is controlled so that the bead 12 c drops more slowly than the time it takes the hook 18c to reach the position shown in FIG. 1b the bead is snagged and arrested by the hook. After the tension is removed from the line the weight acting through the bead and the shaft 16 orients the pendulum in a vertical position as shown in FIG. 1c, in which the weight vector is aligned with the axis of the shaft 16. The pendulum can similarly be raised to the position shown in FIG. 1a when the bead 12c is initially below the pendulum by first riding up along the cam edge C1 and, after passing the tip 18d, riding up the cam edge C2 as shown.

The relative dimensions between the diameter of the bead 12c and the spacing or separation of the plates or sidewalls 18′ is best shown in FIG. 1d. While a latch 10 is formed of stamped or sheet material the latch can be used in numerous applications. Significant higher loads and stresses can be exerted on latches formed of machined or cast parts.

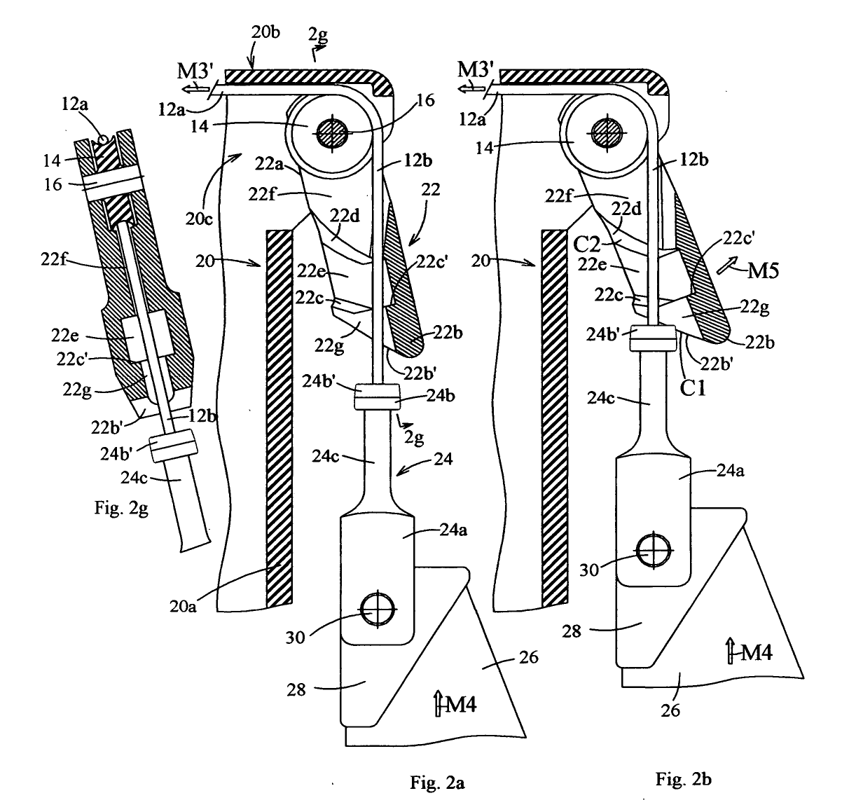

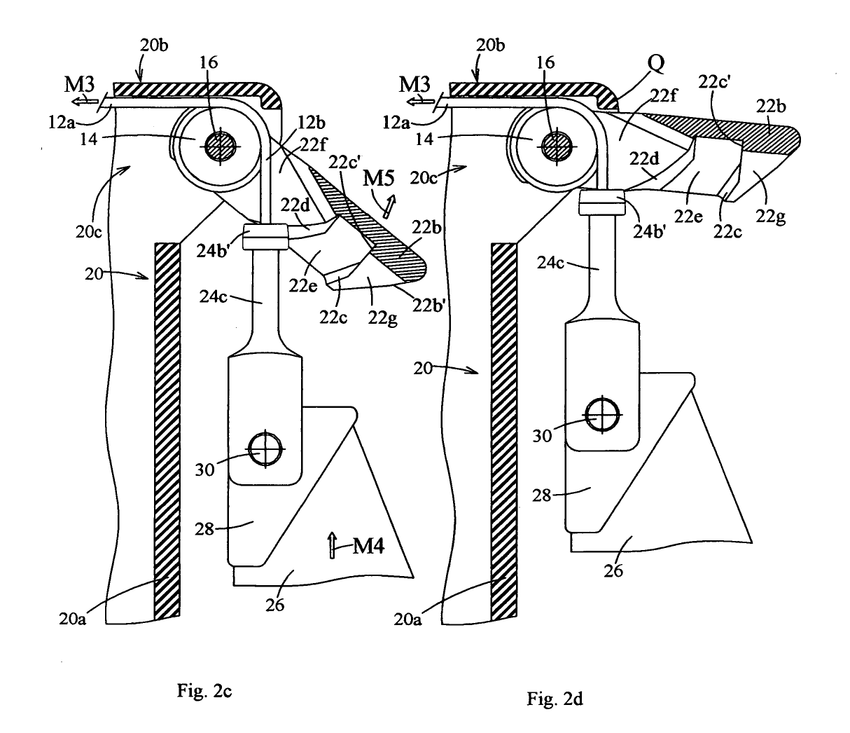

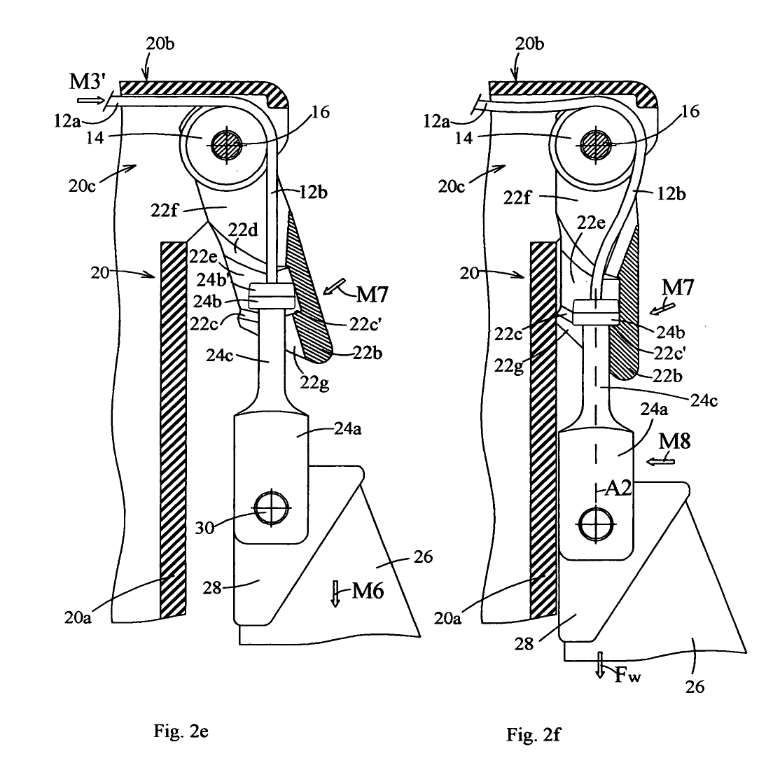

Referring to FIGS. 2a-2f a latch in accordance with the invention shown mounted at the top of a mast 20, generally including a hollow vertical post 20a and a masthead 20b, forming an open cavity or region 20c in which the sheave or block 14 is rotatably mounted about a horizontal shaft bearing 16. As will be appreciated, for small and racing yachts a mainsail 26 is either lowered or raised to the uppermost position, along direction M4 to bring the reinforced head 28 of the sail to the region proximate to the sheave 14. The pendulum 22, forming a top lock, includes a yoke formed of legs 22a, 22a′ and is rotatably mounted for pivoting action about the shaft 16. As is best shown in FIG. 2b the interior of the pendulum 22 is provided with a series of zones, an upper zone A at 22f having a width substantially corresponding to the diameter of the line or halyard to allow the same to pass with some clearance; a somewhat enlarged zone B at 22g dimensioned to substantially corresponded to the diameter of the neck 24c of the shackle 24 that attaches the portion 12b of the line or halyard to the mainsail 26 that is received within the yoke 24a of a shackle and secured by a rivet, pin 30 or the like. The largest zone is zone C at 22e dimensioned to receive the head 24b of the shackle 24, as to be described. The pendulum 22 includes a support surface 22c at the lower region of zone C and a cam surface 22d or C2 at the lower region of zone A at the proximate end 22a of the pendulum is secured to the shaft 16, as described, while the lower or remote end of the pendulum 22b is preferably provided with an inclined cam surface 22b′ or C1. Below the cam surface 22d (C2) are two support surfaces 22c, 22c′. The surface 22c′ is dimensioned to support the head 24b of the shackle 24, while the surface 22c is upwardly inclined relative to the surface 22c′ to prevent inadvertent separation or disengagement of the shackle from the pendulum in the shackled condition shown in FIG. 2f.

In operation, when the mainsail 26 is initially hoisted by pulling the halyard portion along direction M3 the shackle 24, together with the mainsail 26, are raised along direction M4 until the head 24b of the shackle makes contact with and engages the lower inclined or cam surface 22b′ (C1), as shown in FIG. 2b. Further raising of the shackle 24 causes the shackle head 24b to engage and ride along the inner cam surface 22d (C1) to urge the pendulum to swing or rotate in a counterclockwise direction, as suggested by the arrow M5. For this purpose, the head 24b is preferably provided with a tapered or beveled conical upper end 24b′. Continued raising of the mainsail to its uppermost position, along direction M4 causes continued counterclockwise rotation M5 of the pendulum about the shaft 16 until the pendulum swings approximately 90° to the position shown in FIG. 2d. The latch may be positioned 30-50 m up on the mast. The condition shown in FIG. 2d, in which the mast cannot be lifted any further up and the pendulum can no longer rotate in a counter-clockwise direction is a reference condition for the pendulum. Towards this end an element or component Q (FIG. 2d) may be provided to limit additional counterclockwise rotations of the pendulum. If desired, the halyard may be provided with a marking (not shown) that may be aligned with a marking on the mast or other fixed reference point to confirm that the mainsail has reached its uppermost position, and the pendulum has likewise reached its extreme raised position. In FIGS. 2e and 2f the halyard is controllably released along a direction M3′ to allow the pendulum to swing or rotate in a clockwise direction M7. When dropping the mainsail along direction M6 the pendulum reaches the head of the shackle and engages it, as shown in FIG. 2e. After the shackle and the mainsail are secured by and supported by the pendulum, the tension is removed from the halyard and the pendulum assumes a vertical orientation in which the shackle and the load that it carries are vertically aligned below the shaft of the pulley or block 14. Whenever the load vector A2 for the shackle and its load Fw is offset or laterally shifted off center A1 relative to the axis O of the shaft (M8), a horizontal force component F2 of the weight or load of the mainsail and the shackle on the pendulum is created to urge the pendulum and its shackle to move in the direction of the mast to maintain the pendulum in abutment against the mast, avoiding inadvertent separation of the shackle from the pendulum.

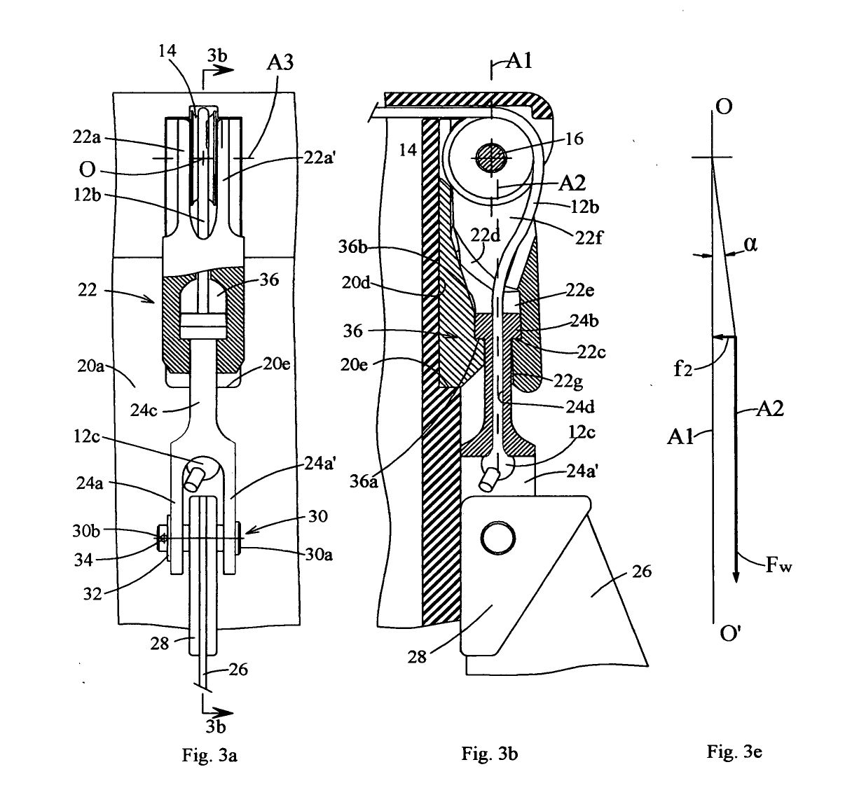

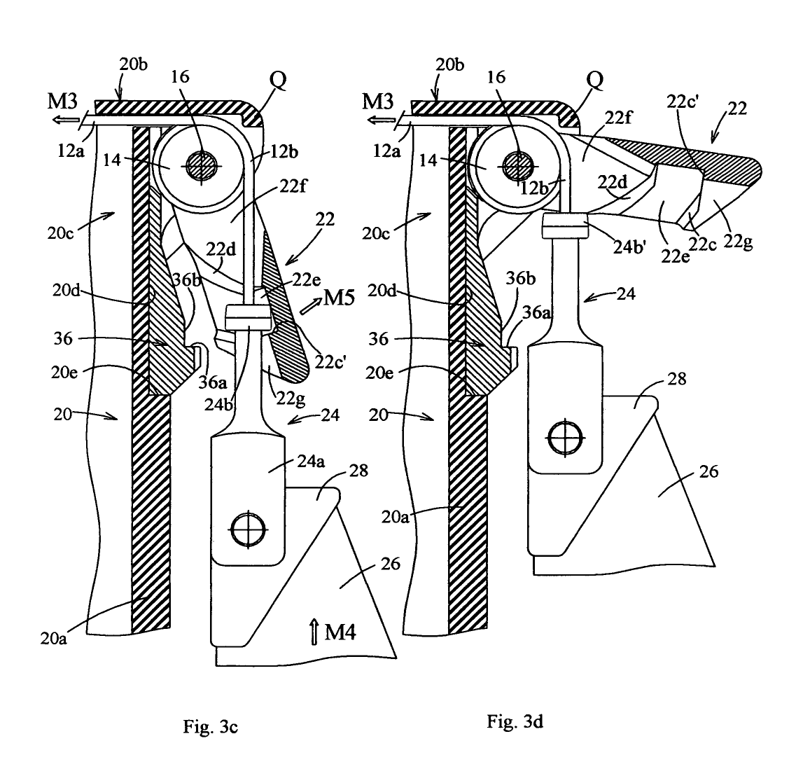

A modified version of the latch is illustrated in FIGS. 3a-3e, in which an additional member 36 is secured to the mast, such as within a cutout 20d and supported by a ridge 20e. The member 36 is provided with a complementary recess 36b for receiving and mating with the head 24b of the shackle 24. It will be appreciated that the member 36 remains fixed on the mast while the pendulum 24 swings as described. However, when the pendulum reaches its vertical position the cams and surfaces that are complementary or mirror images of each other to provide support surfaces for the head of the shackle, providing more peripheral engagement. The shackle 24 is preferably provided with a channel 24d through which an end of the halyard can pass, with the free end provided with a bead or other enlarged protuberance 12c as shown to prevent the end of the line or halyard from slipping through the shackle.

In FIG. 3e the weight or load components of the sail and shackle is represented by F_{w}. When a gap or deflection is established, offsetting the axis A2 from the neutral axis A1 a horizontal force component f2 is created that urges the shackle and sail towards the direction of the mast and the member 36 to enhance security and minimize or totally eliminate any possibility that the shackle will inadvertently separate from the pendulum. As with the previous embodiments, hoisting the sail by pulling on the halyard causes of the pendulum to rotate in a counterclockwise direction away from the mast and the member 36 until the pendulum has reached its extreme position shown in FIG. 3d. As with the other embodiments, whether the sail is released and lowered or secured and maintained in its uppermost position will be a function of the rate at which the halyard is released and, therefore, speed at which the shackle drops in relation to the natural cycle of oscillation or swinging of the pendulum from its uppermost or raised position to a position in which the head of the shackle can be captured and received within zone.

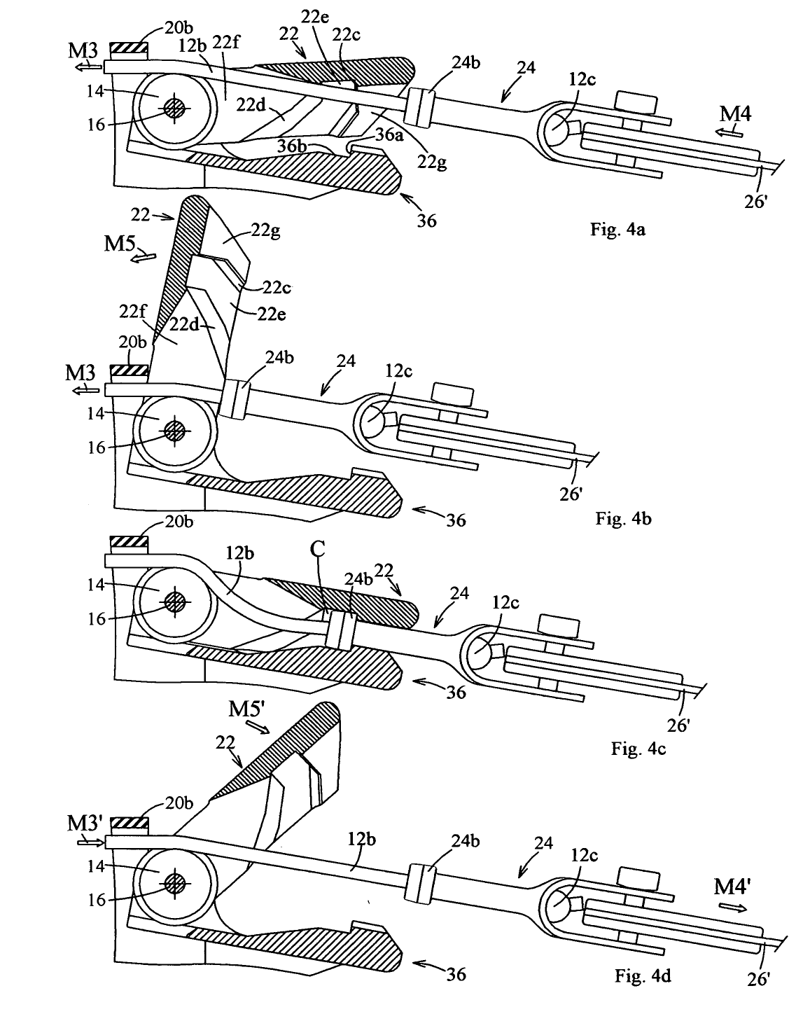

The latch of the present invention need not assume the positions illustrated and discussed thus far for successful operation. Therefore, when the pendulum swings from a reference a horizontal position towards a vertical must to swing a total of approximately 90°. The natural laws of the pendulum, as reflected by the aforementioned formula, are equally applicable regardless of the starting and ending positions of the pendulum. Referring to FIGS. 4a-4d, the pendulum latch is shown used with a spinnaker sail 26′, in which a supplemental or complementary member 36 to the pendulum is also provided. Aside from the changes in the orientations of the working components, the construction of the latch and its operation is the same as previously described. The period of the pendulum 22 still follows the relationship above set forth in the formula, and releasing and arresting or locking motions can continue to be controlled by the user by regulating how quickly or how slowly the halyard is released in relation to the time consumed by the pendulum to complete approximately ¼ of its cyclic period, namely the time it takes the pendulum 22 to move from the extreme position shown in FIG. 4b to the time that it reaches mating relationship, having swung 90°, with the member 36. Either the head of the shackle 24b has moved sufficiently quickly to clear of the hook of the pendulum thereby releasing the halyard or not sufficiently quickly to be hooked by the pendulum and received and locking or blocking relationship within that zone C thereby arresting further advancement of the halyard.

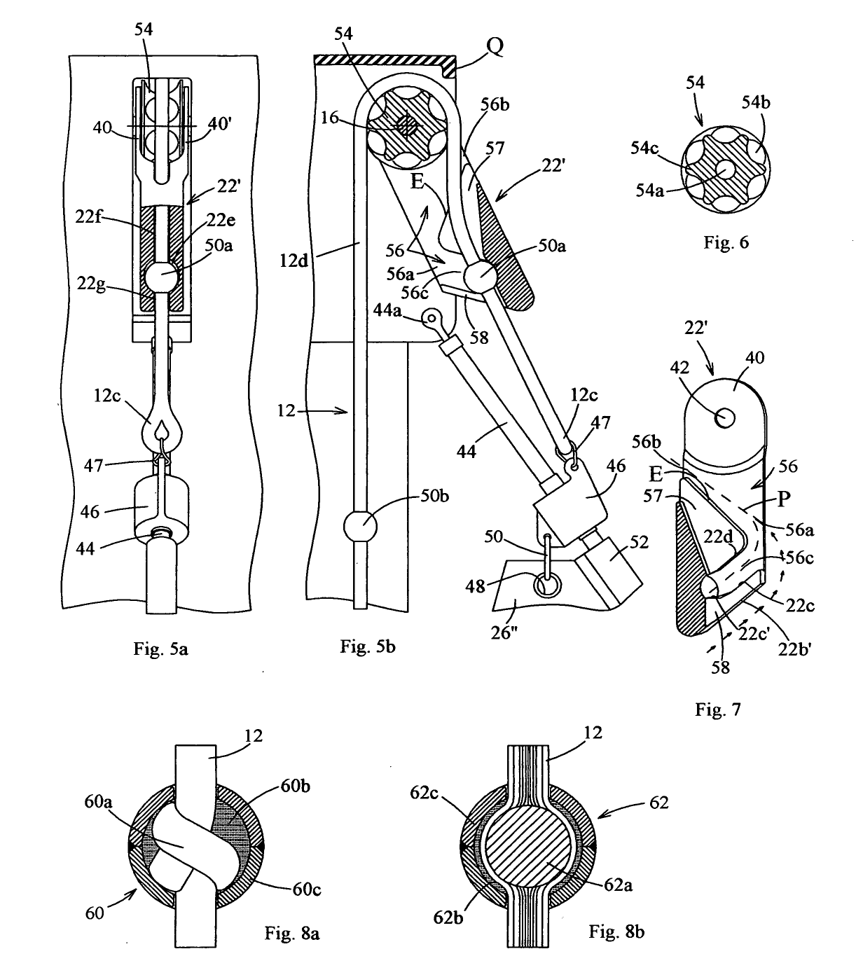

In the arrangements described thus far with relation to FIGS. 1-4 the latch has served as a binary switch locking or releasing the head of the sail when the same is proximate to the head of the mast. These are typical operating conditions during sailing, as the mainsail and a spinnaker are either fully hoisted or fully lowered. In the case of jibs, however, the sails are frequently adjusted and selectively secured in one of a plurality of different positions for exposing different quantities of the sail, depending on the wind conditions. With the jib, therefore, there is a benefit to providing a latch that secures the jib in one of a plurality of positions by adjusting the position of the head of the jib sail, as it is slidably adjusted along the forestay. Referring to FIGS. 5a-7, the jib sail 26″ has its upper portion secured to the forestay 44 by means of a hanking 52, only the upper one being shown, by which the jib has one edge slidably movable along the forestay. The carrier 46 is slidably mounted on the forestay 44 and is secured to the upper end of the jib by means of an eyelet 48 through which a link 50 connects the jib to the carrier so that the upper end of the jib follows the carrier. The carrier 46 is itself controlled by the halyard 12, a free end of which, at 12c, is connected or joined it to the carrier 46 by means of any suitable fastener 47 such as a metal link or loop as shown. It will be appreciated that as the halyard 12 lifts the carrier 46 or releases it, so that it moves downwardly under the force of gravity, the carrier 46 is linked to the jib and the two follow each other upwardly or downwardly along the forestay.

To selectively lock the halyard at multiple selected positions of the jib the halyard is provided with a plurality of spaced beads 50a, 50b, the spacing between the beads being selected to corresponded to incremental heights of the jib. Cooperating with such modified halyard is a modified pulley or block 54 provided with circumferentially spaced recesses 54b that effectively produce correspondingly spaced sprockets or projections 54c, the recesses being dimensioned to receive one of the beads along the halyard. The specific construction of the beads is not critical for purposes of the present invention and any construction suitable for being received within the recesses 54b and capable of withstanding the anticipated stresses can be used. Referring to FIG. 8a one possible construction of the beads 60 is shown in which the halyard 12 is initially tied in a knot 60a. A filler material 60b fills the space about the knot to create a spherical protuberance about the knot. A spherical shell 60c surrounds the core and protects the integrity of the spherical shape so that the bead can be reliably received within a recess 54b on the pulley or block 54. The pulley or block 54 has a central hole 54a for rotatably mounting the pulley or block on a shaft 16. In FIG. 8b, another possible construction of the beads is shown. Here, the bead 62 includes a solid spherical core 62a that may be made of a hard material, such as metal. Plastic filaments, forming the halyard 12, are guided about the core 62a to maintain the spherical shape and these are encapsulated within a layer 62b of any suitable material. Again, an outer spherical shell 62c may be used to provide the desired spherical shape and dimensions required for cooperation with the recesses 54b.

Since with the previously described embodiments the sails were either hoisted to an uppermost position proximate to the masthead or released to be lowered to the foot of the mast the shackle 24 was either engaged with the pendulum 22 or disengaged from it, as described. In those arrangements, the head 24b of the shackled either lifted the pendulum to its upper position or was snagged by the pendulum and received within and supported by the pendulum. The shackle never moved beyond the pendulum or beyond the block 14 but was always below the pendulum in the block. However, in order to accommodate multiple positions of latching not only the block 54 assumes a new design from conventional blocks but the pendulum must also be modified. Referring to FIG. 7, a modified pendulum 22′ is shown that not only allows of the beads 50a, 50b . . . 50n to be selectively snagged to latch the line 12 with any of the beads but also allows the beads to effectively pass it through the pendulum 22′ and over the modified block or pulley 54 to bring the next successive bead into play. To achieve this, the pendulum 22′ is provided with the 3 regions or zones 56, 57 and 58 each defining successively decreasing widths. The zone 56 is the widest and allows a bead of a selected a predetermined the diameter to pass from one or lateral end or opening 56a to another lateral end or opening 56b. Zone 57 and 58 are sufficiently wide to accommodate the halyard 12 but not sufficiently wide to receive any of the beads. The pendulum 22′, forming a top lock, includes a yoke formed of legs 40, 40′ and is rotatably mounted for pivoting action about the shaft 16 through the hole 42.

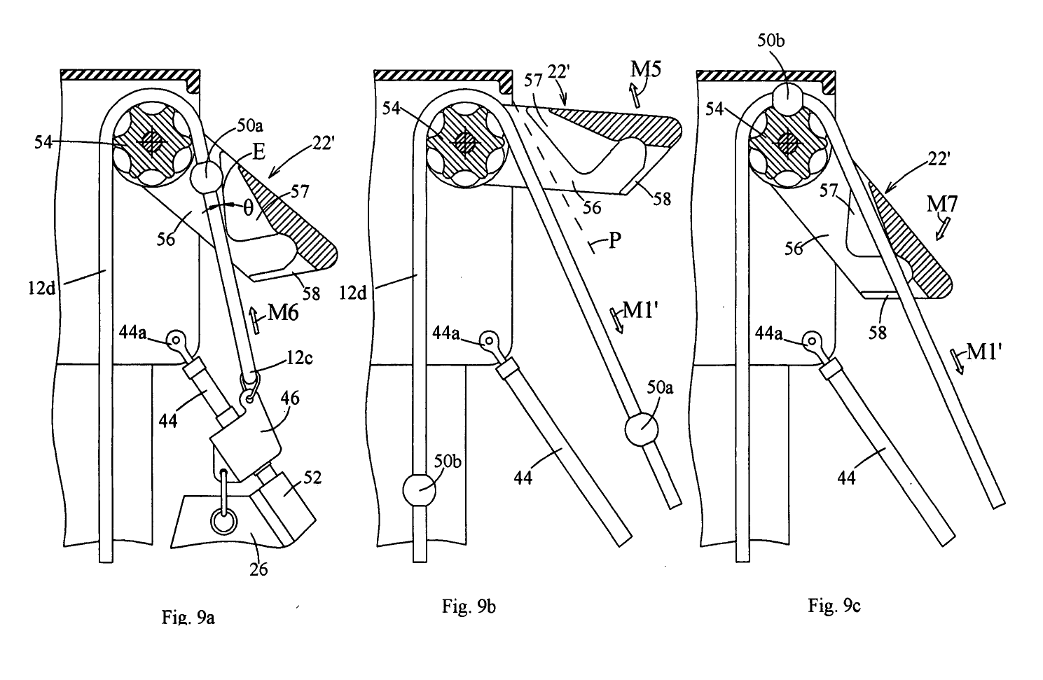

Thus, a path P is made available for a bead to enter one of the lateral ends or openings 56a, 56b and exited through the other when the pendulum 22′ is in its raised or “set” position shown, for example, in FIG. 9b. However, when the halyard extends and generally along the length the direction of the pendulum, such as shown in FIGS. 5b and 9c, the raised, cam surface defining region 57 is arranged to interfere with the free movement of the beads 50a or 50b, the beads interacting with the cam 57 to deflected it, as to be described. An important feature of the pendulum 22′ is fact and edge E of the cam defining the region 57, facing the beads and the halyard, is arranged to abut against a bead in the raised or cocked position of the pendulum and define an angle θ with the halyard 12 (FIG. 9a). With this arrangement, with the carrier 46 and the bead 50a are allowed to flow freely under the action of gravity the bead 50 slides along the edge E and imparts a force to the pendulum 22′ that causes it to swing in a counterclockwise direction M5 to a position, shown in FIG. 9b, that is still higher than the “cocked” or “set” position shown in FIG. 9a. However, this higher position is unstable and as soon as the pendulum reaches the highest position attainable by the momentum imparted by the inter-acting bead it immediately starts to fall under its own weight. However, during the time that the pendulum is forced by the dropping bead to rise and to revert to a position proximate to the halyard the latter, and the beads supported thereon, are free to advance along the path P (FIG. 9b). As in the previous embodiments, if the beads are moved sufficiently quickly they will avoid being snagged by the pendulum, while if the halyard is manually retarded or held back somewhat the pendulum will return in time to snag a more slowly moving bead. It will be clear, however, that with this embodiment the time for the swinging of the pendulum from the position shown in FIG. 9a to the position shown in FIG. 9b may be approximately twice the time it takes for the pendulum to move from its “cocked” or “set” positions with the previous embodiments since only a quarter of an oscillation or cycle is used to for the previous embodiments while with the current embodiment the pendulum is initially propelled upwardly and then drops back to its initial position for approximately one half of an oscillation or cycle. The speed with which the halyard is released or retarded can be controlled accordingly.

The operation of the embodiment described above for use with a jib sail 26″will be more specifically described in connection with FIGS. 5a-7 and FIGS. 9a-9c. In FIGS. 5a-5b the bead 50a is shown captured within the pendulum 22′ to maintain the carrier 46 in the upper end of the jib sail 26″ is in the upper position shown. To release the halyard 12, and thereby lower the jib sail 26″, the halyard is initially hoisted upwardly along direction M6, thereby raising the pendulum by rotating it in a counterclockwise direction until the pendulum reaches its “cocked” or “set” position as shown in FIG. 9a. Release of the halyard and thereby also the sail sufficiently rapidly causes the bead 50a to propel the pendulum 22′ to the unstable elevated position shown in FIG. 9b. During this time the pendulum does not interact with the halyard or the beads and these can freely move along the path P (FIG. 9b), escaping from the lower portion or hook end of the pendulum. Again, as before, locking the halyard requires a slower release so that the bead approaches the position of the hooked end of the pendulum prior to the bead arriving at that position. However, in each instance, operation is extremely simple and predictable. The sailor or operator simply pulls on the halyard to raise the pendulum to the “cocked” or “set” position of FIG. 9a and quickly releases the line to allow the sail to drop under the action of gravity, this allowing the associated bead to escape the pendulum that must first rise to the position shown in FIG. 9b and then revert under the action of gravity to the position shown in FIG. 9c. When the line is to be arrested the halyard is released more slowly, thereby retarding the speed and reducing it sufficiently to allow the pendulum to approach its lower position shown in FIG. 5b, having traveled approximately 180°, when it becomes receptive to receiving the bead as it passes the hooked end of the pendulum. When two or more beads are spaced along the halyard, the same operation can be performed for each individual bead corresponding to a different desired height position of the jib. Suitable markings on the halyard as well as a reference member, such as the mast, can be helpful to indicate to the operator which bead is about to come into play and positioned in a “cocking” or “setting” position as in FIG. 9a and, therefore, which height position the jib will assume. Typically, the jib does not assume different heights for small on sailing vessels. However, on larger boats and racing yachts the jib can typically be adjusted anywhere from 2-4 positions.

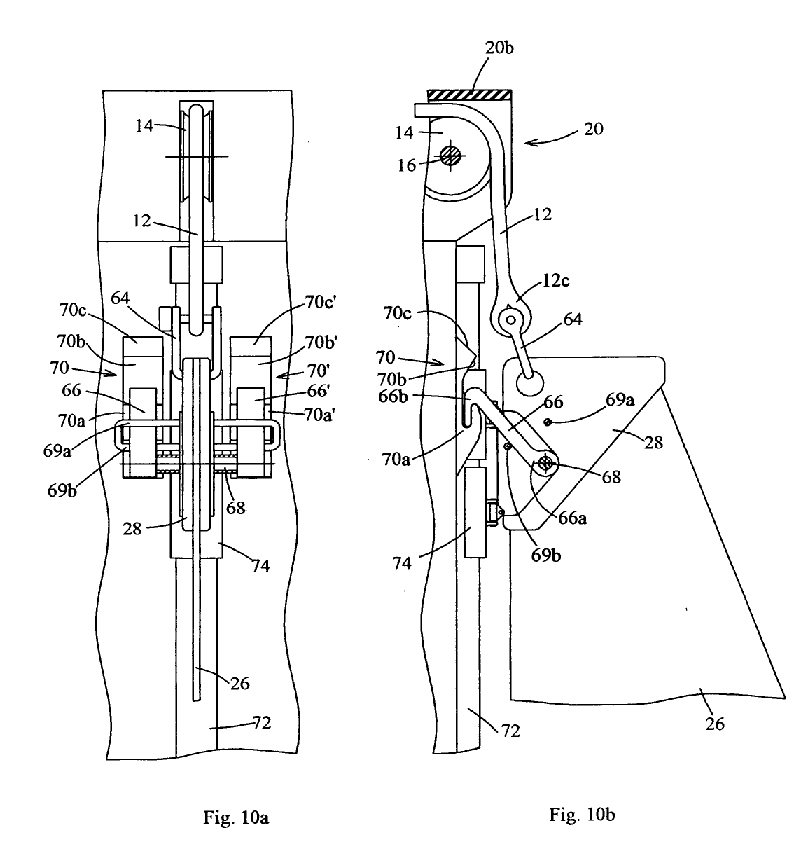

In FIGS. 10a-10b a further embodiment of the latch is shown that can be used in connection with a mainsail on a big yacht or racing vessel, in which the mainsail may be required to be adjusted to multiple positions along the mast. Three different positions are typical, although any number of such positions may be used. Here, the free end 12c of the halyard 12 is securely attached to the mainsail 26 by means of a shackle 64 in a conventional manner. The reinforced head 28 of the mainsail has mounted on it a pendulum 66 that moves vertically upwardly and downwardly with the movements of the mainsail. The angular rotational positions of the pendulum, about a pin 68, are controlled by limiting pins 69a, 69b. Mounted vertically along the mast 20 is a track 72 in a conventional manner, spaced slides 74 attached to the mainsail 26 being arranged to slidably move along with the track 72. Accordingly, the release of the halyard 12 causes the mainsail to slide along the mast due to movements of the slides along the track. With this arrangement, the slides insure that the luff edge of the mainsail facing the mast is maintained at a predetermined distance from the mast independently of the vertical positions of the sail. In this arrangement, the pendulum 66 has a proximate end 66a pivotally mounted on a pin 68 for pivoting movements between the two limiter pins or stops 69a, 69b. The pendulum also has a hook 66b at the remote end. The pendulum 66, therefore, moves between a releasing position when it is up against the limiter 69a and a locking position, when it is dropped and rests upon the limiter 69b, as shown in FIG. 10b.

Mounted on the mast 20 is at least one deflector 70 provided with an upwardly open recess in the form of a hook 70a and, above the recess, angled surfaces 70b, 70c that are inclined outwardly in the upward direction, on the one hand a, and inwardly in the upward direction, on the other hand, respectively, as shown. The hook 66b is dimensioned to be received within the recess 70a to interlock with and maintain the head of the sail locked at a specified height of the mast.

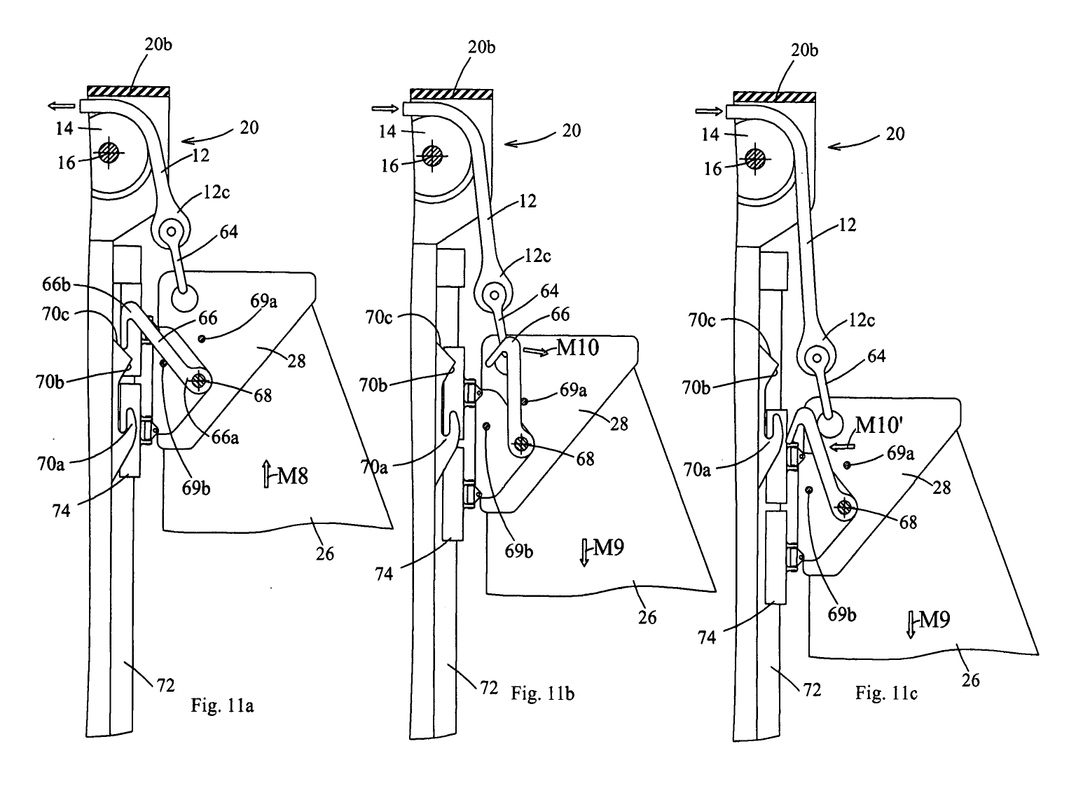

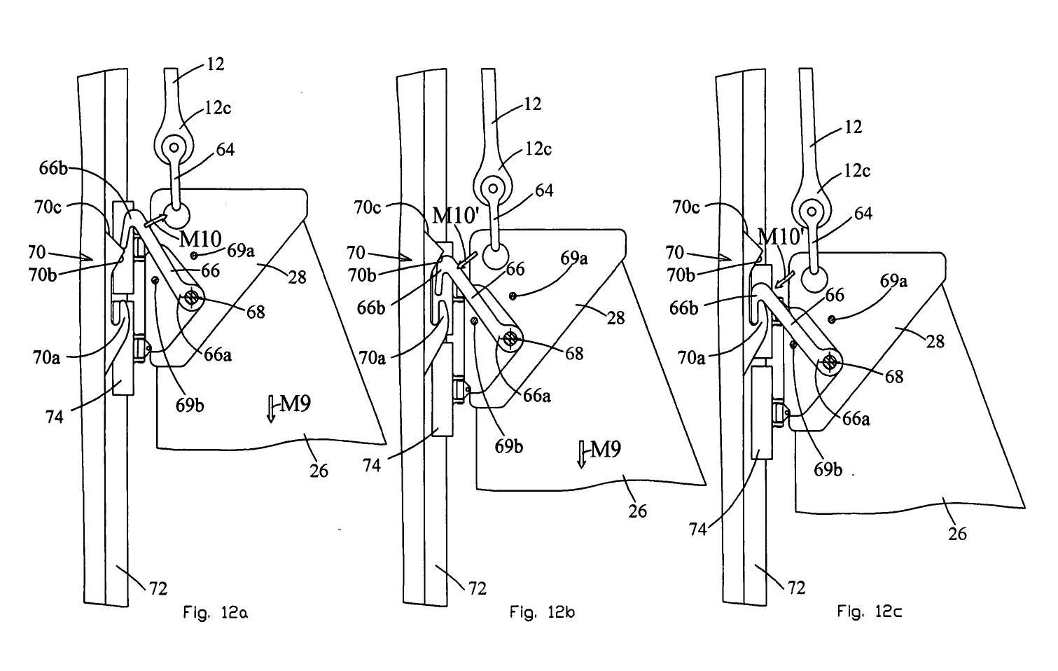

Referring to FIGS. 11a-11c the sequence is illustrated for releasing the hook 66b and, therefore, the mainsail 26, from deflector assembly 70 situated at the top of the mast. Initially, the halyard is hoisted along direction M8 to extricate the hook 66b from the recess 70a and lifted sufficiently so that the hook 66b rests on the surface 70c as shown in FIG. 11a. Release of the halyard, along direction M9, causes the pendulum 66 to be propelled in a clockwise direction, as suggested by arrow M10 in FIG. 11b. The pendulum 66 will tend to rotate in a counterclockwise direction M10′, particularly if the center of mass is vertically offset from the limiter pins 69a, creating a moment to rotate the pendulum. On the basis of the pendulum formula, the pendulum will reach the position of the deflector assembly within a preset time. If the halyard is released sufficiently quickly the hook 66b will not reach the recess 70a by the time that the hook vertically drops below the deflector assembly, as suggested in FIG. 11c. In this condition, the halyard may continue to be released without interference from the pendulum locking assembly. However, referring to FIGS. 12a-12c, when the halyard is released more slowly the hook 66b has more time to more fully rotate in a counterclockwise direction M10′ before the hook 66b passes the deflector assembly and the hook is snagged and received and held by the deflector assembly, namely the recess 70a.

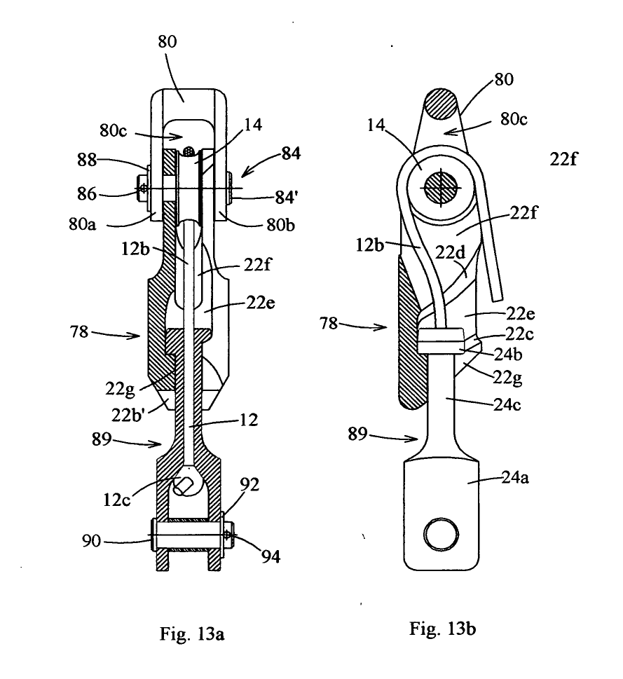

While the pendulum latch in accordance with the present invention has been described in the context or environment of sailing boats, ships or yachts, where it can be used very effectively, the pendulum latch can also be used in many other applications—whenever selective locking and releasing between two elements or components is desired, preferably by remote actuation. Referring to FIGS. 13a-13b, for example, a standalone latch in accordance with the invention is generally designated by the reference numeral 78 and includes an upper yoke 80 formed of spaced legs 80a, 80b to form a central opening or space 80c through which any attachment or member may be used to connect and support the latch, such as a line, hook, or the like. Supported on the yoke 80 is the latch mechanism constructed substantially as previously described. Secured to the yoke by means of a shaft or pin 84 provided with a head 84′ at one end and a washer 88 and cotter pin 86 may be used to secure the pin 84 on the yoke. The lower end of the shackle 89 may also be formed with a yoke 24a and a pin 90 and secured by means of a washer 92 and cotter pin 94. The lower end of the shackle, therefore, can also be secured to an object that is to be raised and lowered by means of line 12 secured to the shackle.

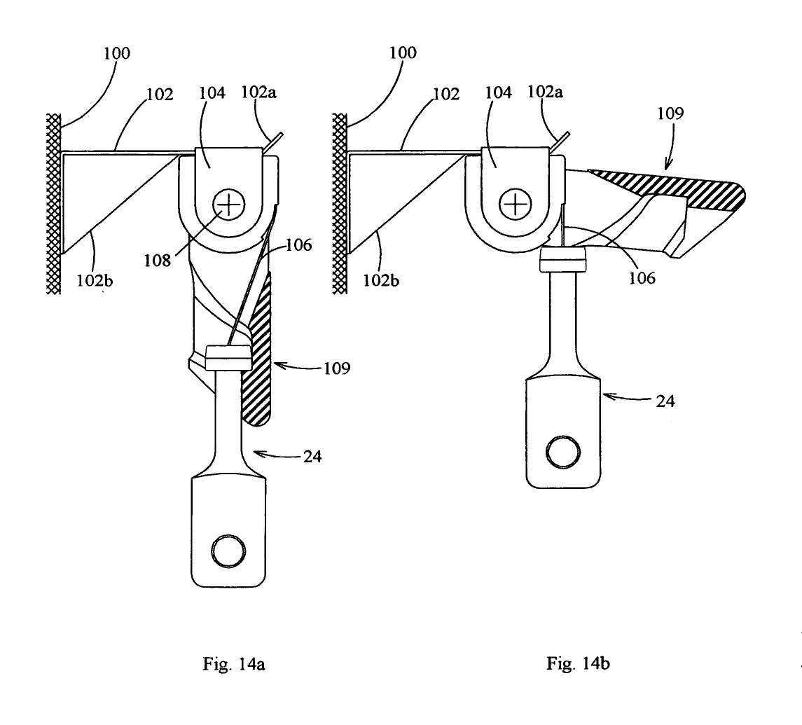

In FIGS. of 14a-14b, a further application as illustrated in which the pendulum latch is secured to a vertical surface such as a wall 100. Supported on the wall is a bracket 102 having a raised lip 102a and an angle support 102b. Supported on the bracket 102 by means of a yoke-type structure is a tape measure housing 104 within which there is provided a spring-loaded mechanism for winding a tape 106 similar to spring-loaded mechanisms used in tape measures. The housing 104 and the pendulum 109 are mounted on a shaft 108 about which the pendulum may swing. The head of the shackle 24 is secured to the tape 106. In this application, there is no hoisting the line for pulling up the shackle. Instead, the shackle is manually raised. Thus, for example, when the shackle is used to support a potted plant the plant and its pot are physically raised, the spring-loading mechanism within the housing 104 taking up the slack and rewinding the tape as the exposed part of the tape is a shortened. At the same time, the head of the shackle engages the cam surfaces of the pendulum and raises it to the position shown in FIG. 14b. As with the other described embodiments, when the shackle is released slowly the head of the shackle will be snagged by the pendulum and locked in place as shown in FIG. 14a. However, when the shackle and potted plant or any other item supported thereby, is to be lowered from the raised position shown in FIG. 14a the shackle is allowed to be lowered more rapidly, thereby avoiding being snagged by the swinging pendulum.

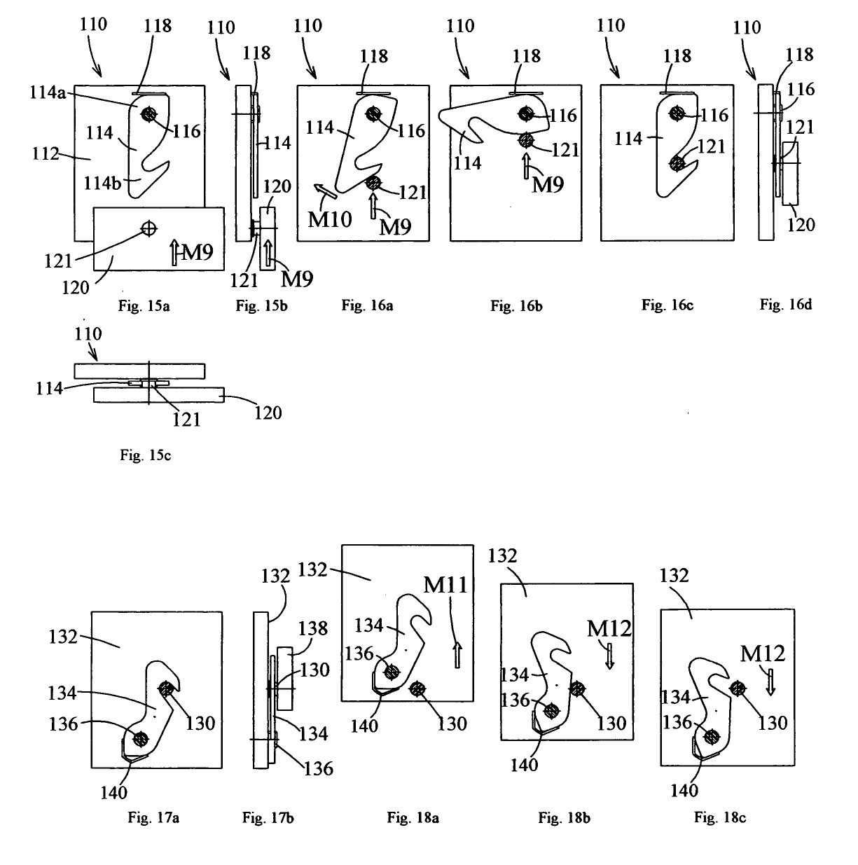

In FIGS. 15a-15c a further application of the pendulum latch in accordance with the invention is illustrated in which the pendulum 114 is mounted on a fixed body or surface. In the embodiment shown, for example, a wall 110 has a surface 112 on which there is pivotally mounted a pendulum 114 about a pivot pin 116. The upper, pivoted portion 114a interacts with a limiter 118 for preventing excessive rotational movements exceeding approximately 90°. The pendulum 114 is provided with a lower hook portion 114b adapted to engage a movable device, such as a cabinet or the like, that is either to be secured at the height of the latch or lowered. Referring to FIGS. 16a-16d, the operation will be described. When the cabinets 120 is raised (M9) the pin 121 engages the pendulum and causes it to swing in a clockwise direction (M10), as suggested in FIGS. of 16a-16b. The limiter 118 prevents further rotation. As with the previous pendulum latches, when the cabinet 120 is to be locked and retained the height of the pendulum it is lowered slowly enough to allow the pendulum to swing in a counterclockwise direction and it to cause the hook on the pendulum to snag the pin 121 on the cabinet, thereby securing it and fixing it in place. As before, if the cabinet is to be released and lowered below the latch it is, again, initially raised to bring the pendulum to the position shown in FIG. 16b, but then it is lowered at a more rapid rate to drop below the hook of the pendulum by the time that the pendulum has the time to reach of the vertical position shown in FIGS. 15a and 16c.

In FIGS. 17a and 17b a reverse arrangement is shown for what has been described in connection with FIGS. 15a-16d. Here, it is the pin 130 that is fixed on a stationary surface 132. The pendulum 134 is pivotally mounted by means of pivot pin 136 on a movable object 138 by raising the object (M11) to suitably deflect the pendulum. The limiter 140 prevents further rotation. The pendulum can be made to engage the fixed pin 130 or bypass it, depending on the rate of descent (M12) of the object and the pendulum relative to the fixed pin.

As will be appreciated, therefore, the pendulum latch in accordance with the present invention can be used in numerous applications where an object is intended to be selectively released or locked at a predetermined position in relation to another object, preferably without a user physically contacting any part of the pendulum latch. This makes it particularly suitable and useful for controlling the operation of a latch remotely, such as latching a sail at the top of the mast. The pendulum latch of the present invention can be operated without reliance on inertia and with a minimal number of parts. This renders the pendulum latch extremely economical to manufacture and reliable in various field uses and adverse environmental conditions. It does not rely on or require auxiliary escape mechanisms, such as trip lines or the like nor does it rely on critical distances of movements for reliable operation. Instead, the latch only and simply relies on the physical oscillation property of a pendulum that is well understood and is not subject to variations. A user, such as a sailor on a boat, can quickly and easily learn how to operate the pendulum latch of the invention and master such operation without too much difficulty.

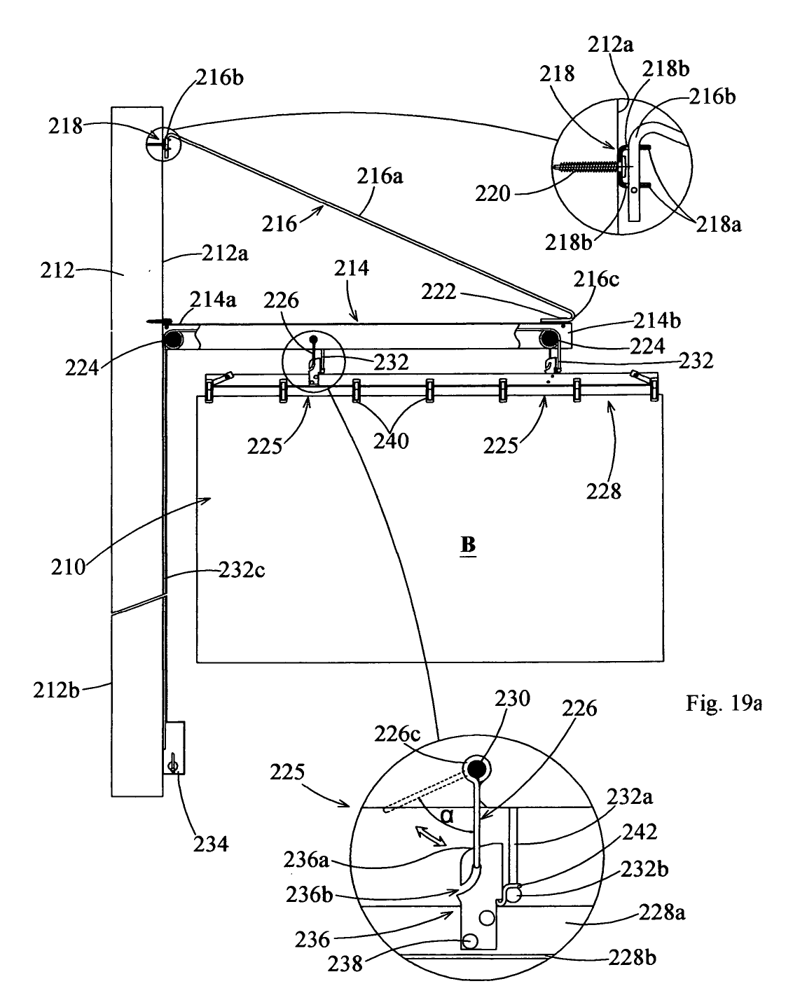

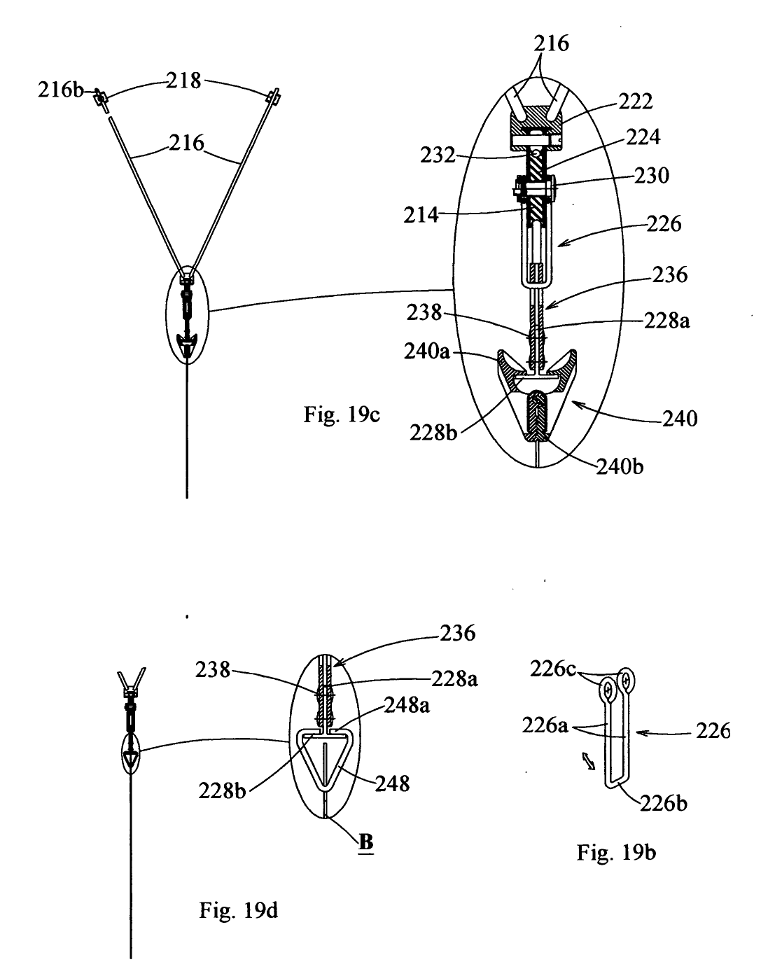

Referring to FIG. 19a a lifting/lowering device for banners B is designated by the reference numeral 210. The device 210 is mounted on a support structure 212, such as an exterior wall of a building that has an exterior surface 212a and an interior surface 212b. The device includes a fixed horizontal member or channel 214 having a fixed end 214a and a free end remote from the structure 212. A brace 216 extends between the support structure 212 and the free end 214b as shown to absorb the load of the weight of the banner B and supporting mechanism and prevent or reduce the bending of the fixed support member. The brace 216 includes a rod 216a, an upper hook 216b and a lower hook 216c. The upper hook 216b cooperates with an anchor fastener 218. As best shown in the enlarged inset, the anchor 218 is in the form of a generally C-shaped bracket having upper and lower space portions 218a provided with vertically aligned holes 218b and a hole 218c in the connecting or bridging portion. The hook 216b has a vertical portion as shown that is received within the holes of 218b once the bracket 218 is secured to the surface 212a by means of the fastener or screw 220. Any suitable fastener 222 may be used to secure the generally horizontal portion of the lower hook 216c to the remote free end 214b as shown.

Pulleys or sheaves 224 are provided one at each end of the fixed end 214a and remote free end 214b as shown, the horizontal member or channel 214 being broken away at both ends in FIG. 19a to illustrate the positions of the sheaves.

A pair of spaced pendulum latches 225 are shown for releasably fixing a movable substantially horizontal support member 228. The member 228 is in the form of a T-shaped extrusion defining a vertical planar leg portion 228a and a horizontal planar portion or ledge portion 228b. The pendulum latches 225 include pendulums 226, best shown in FIG. 19b as a U-shaped wire formed of two parallel legs 226a joined with a bridging portion 226b and provided with circular loops 226c. The pendulums can move from a lowered vertical rest position, as shown in the enlarged inset, and be angularly elevated or pivoted by an angle α, shown in Phantom outline in the enlarged inset. The pendulums are supported on the fixed horizontal member 214 by means of pins 230.

A pair of lines 232 have ends 232a terminating proximate to the movable horizontal member 228 and provided with a ball or knot 232b. The free ends of the lines 232c are downwardly directed to align with a storage box 234 where excess line may be stored. The pendulum latches 225 include hooks 236 provided with rounded edges 236a that serve as cams for deflecting the pendulums 226 as described and are provided with openings 236b for capturing the bridging portion 226b. Rivets 238 secured the hooks 236 to the movable member 228. Spring clips 240 are configured to be slidably supported on the horizontal ledges 228b as shown in the enlarged inset and are provided with finger grips 240a for selectively opening jaws 240b against the action of suitable biasing means (not shown). Eylets 242 secure the line portions 232a to the hooks 236.

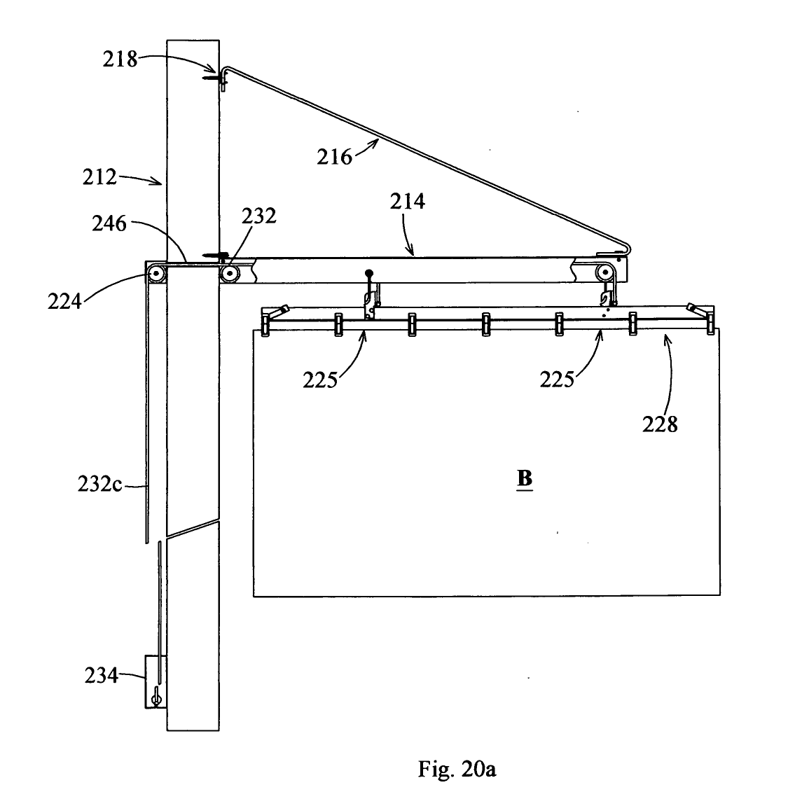

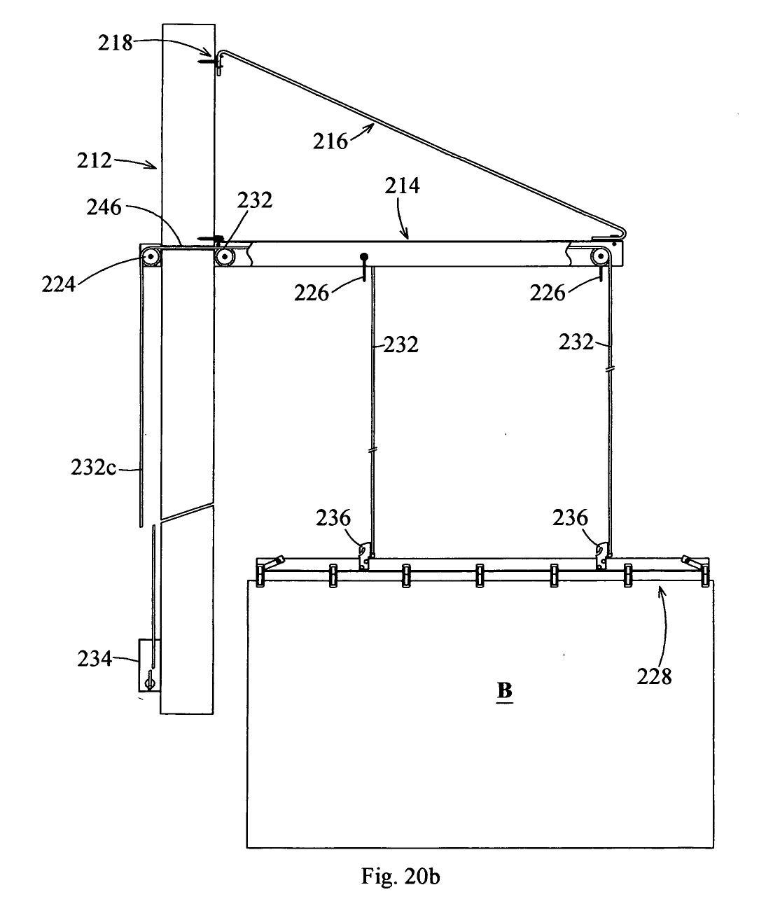

Referring to FIG. 20a the banner device shown in FIG. 19a is modified to bring the lines 232 through a channel 246 in the support structure or wall 212 so that excessive line can be stored within a line storage box 234 inside instead of outside of the structure wall.

Referring to FIG. 19d and the enlarged inset, an alternative embodiment is illustrated in which the spring clips 240 are replaced by generally triangular loops or links 248. While the spring clips 240 grip the opposing surfaces of a banner B, the links or loops 248 require holes to be formed along the upper edge of the banner through which the links or loops may pass. Otherwise, the operation of the two devices is the same. Referring to FIGS. 20a, 20b, the banner B is shown in raised, locked position proximate to the fixed horizontal member or channel 214, where it is elevated above traffic or pedestrians, and released lower position suitable for changing the banner where it is convenient to do so without ladders or the like.

The present invention is by no means restricted to the above-described preferred embodiments, but covers all variations that might be implemented by using equivalent functional elements or devices that would be apparent to a person skilled in the art, or modifications that fall within the spirit and scope of the appended claims.

What is claimed:

1. A remotely actuatable latch for locking and releasing an object at a location remote from a user, comprising
a. a sheave mounted at the remote location for free rotation about an axis;
b. a line coupled to or engaged with said sheave and having one end coupled to an object to be selectively locked or released at said remote location and an opposing end that can be gripped and manually manipulated by a user at a location spaced from said remote location;
c. a shackle connecting the object to said line; and
d. a pendulum at said remote location for pivoting movements between a stable position and an unstable position and positioned along the path of movement of said line and shackle when a user pulls or releases said opposing end, said pendulum having a cam surface for deflecting said pendulum responsive to movements of said shackle along said path of movement past said pendulum towards said sheave to cause said shackle to ride along said cam surface thereby angularly pivoting said pendulum from said stable rest position to said unstable position, said pendulum having means for engaging said shackle and having a natural period of oscillation selected to require a time τ to move from said unstable to said stable positions, whereby release of said line to allow said shackle to free fall past said pendulum with a time less than τ allows said shackle to clear said pendulum and unlock said object while controlled release of said line to move said shackle with a time sufficiently greater than τ causes said pendulum engaging means to engage said shackle and fixedly secure said object to said pendulum, whereby a user can lock or unlock said shackle and therefore also said object at said remote location by controlling the speed of release of said line.

2. A remotely actuatable latch as defined in claim 1, wherein said shackle has a head connected to said line and said pendulum engaging means comprises a receiving space configured to receive said shackle head.

3. A remotely actuatable latch as defined in claim 1, wherein said shackle comprises a hook defining receiving channel and said pendulum comprises a loop dimensioned to receive said hook.

4. A remotely actuatable latch as defined in claim 1, wherein said shackle comprises a protuberance on said line and said pendulum includes a hook with a receiving region dimensioned to receive said protuberance.

5. A remotely actuatable latch as defined in claim 4, wherein said protuberance comprises a generally spherical bead or ball fixed to said line.

6. A remotely actuatable latch as defined in claim 1, wherein said shackle is attached to the upper end of a sail and said sheave and pendulum are pivotally mounted at the top of a mast.

7. A remotely actuatable latch as defined in claim 1, wherein said stable position of said pendulum is a position angularly displaced from a vertical position and said stable position is a position coextensive with said vertical position.

8. A remotely actuatable latch as defined in claim 7, wherein said angular displacement from said vertical position is within the range of 1°-90°.

9. A remotely actuatable latch as defined in claim 1, wherein a plurality of protuberances are provided along said line and spaced from each other, said sheave including means for allowing any of said protuberances to extend over said sheave to modify the length of line between said sheave and said shackle, whereby the object can be selectively locked to said pendulum at a plurality of discreet positions.

10. A remotely actuatable latch as defined in claim 1, wherein said shackle is mounted on a fixed surface and said pendulum is mounted on the object, said line being attached to said object to raise and lower said object along a path in close proximity to said shackle.

11. A remotely actuatable latch as defined in claim 1, wherein said sheave and pendulum are mounted on a bracket attached to a surface and such as a wall, whereby said shackle can lock or release an object in close proximity to said bracket.

12. A remotely actuatable latch as defined in claim 1, wherein said pendulum includes a hook pivotally mounted on a fixed surface and said shackle includes a pin mounted on an adjacent surface movable in a parallel plane in close proximity to said fixed plane and receivable within said hook.

13. A remotely actuatable latch as defined in claim 12, further comprising biasing means for maintaining said pendulum in said stable position.

14. A remotely actuatable latch as defined in claim 1, wherein said pendulum includes a hook pivotally mounted on a movable surface and said shackle includes a pin mounted on an adjacent surface fixed in a parallel plane in close proximity to said fixed place whereby said hook can engage said pin.

15. A remotely actuatable latch as defined in claim 1, further comprising biasing means for maintaining said pendulum in said stable position.

16. A remotely actuatable latch as defined in claim 1, wherein said shackle includes a three-dimensional member to be engaged by said pendulum.

17. A remotely actuatable latch as defined in claim 1, wherein said shackle includes a substantially two-dimensional member to be engaged by said pendulum.

18. A remotely actuatable latch as defined in claim 1, wherein a plurality of pendulums are supported in spaced relationship from each along a fixed generally horizontal support member and a plurality of shackles are provided on a movable generally horizontal support member, a plurality of line and a corresponding plurality of sheaves being mounted on said fixed support member, associated pendulums and shackles being aligned to allow selective locking and releasing of said movable support member relative to said fixed member.

19. A remotely actuatable latch as defined in claim 18, further comprising a banner or sign secured to said movable member to allow said banner or sign to be locked in an upper position proximate to said fixed support member or released and lowered to change the banner or sign.

20. A method for remotely actuating a latch for locking and releasing an object at a location remote from a user, comprising
a. mounting a sheave at the remote location for free rotation about an axis;
b. coupling or engaging a line with said sheave and coupling one end to an object to be selectively locked or released at said remote location and an opposing end that can be gripped and manually manipulated by a user at a location spaced from said remote location;
c. connecting a shackle to the object and to said line; and
d. mounting a pendulum at said remote location for pivoting movements between a stable position and an unstable position and positioned along the path of movement of said line and shackle when a user pulls or releases said opposing end, said pendulum having a cam surface for deflecting said pendulum responsive to movements of said shackle along said path of movement past said pendulum towards said sheave to cause said shackle to ride along said cam surface thereby angularly pivoting said pendulum from said stable rest position to said unstable position, said pendulum having means for engaging said shackle and having a natural period of oscillation selected to require a time τ to move from said unstable to said stable positions, whereby release of said line to allow said shackle to free fall past said pendulum with a time less than τ allows said shackle to clear said pendulum and unlock said object while controlled release of said line to move said shackle with a time sufficiently greater than τ causes said pendulum engaging means to engage said shackle and fixedly secure said object to said pendulum, whereby a user can lock or unlock said shackle and therefore also said object at said remote location by controlling the speed of release of said line.
